(19) United States
(12) Patent Application Publication
(10) Pub. No.: US 2022/0032810 A1
(43) Pub. Date: Feb. 3, 2022

(54) Method of Operating a Charging Station System

(71) Applicant: innogy SE, Essen (DE)

(72) Inventors: Carsten Rietfort, Bottrop (DE); Bert Vollmann, Düsseldorf (DE)

(21) Appl. No.: 17/299,964

(22) PCT Filed: Nov. 7, 2019
(86) PCT No.: PCT/EP2019/080487

§ 371 Date: Jun. 4, 2021

(30) Foreign Application Priority Data
Dec. 7, 2018 (DE) 10 2018 131 315.2

(51) Int. Cl. B60L 53/66; B60L 53/68

(52) U.S. Cl. CPC B60L 53/665; B60L 2240/72; B60L 53/68

(57) ABSTRACT

The invention relates to a method of operating a charging station system used to charge a battery storage of a motor vehicle, wherein the charging station system comprises at least two charging stations, a back end, and a communication device which is managed by a user to charge the energy storage.

The invention relates to a method for operating a charging station system with which an energy storage of a motor vehicle is charged, wherein the charging station system comprises at least two charging stations, a back end and a communication device which is managed by a user for charging the energy storage. Thereby, the user launches an application of the communication device that displays the charging stations to the user, wherein the user uses the communication device to select a charging station at which the user plans to charge the energy storage of the motor vehicle using a selected charging station. The communication device sends user-specific data and/or charging station-specific data to the back end, which the back end receives, wherein the back end verifies the user-specific and/or charging station-specific data sent by the user to the back end. The back end sends tariff data to the communication device and/or to the charging station selected by the user, which the communication device and/or the charging station receives.

A charging system is known from the prior art, which is designed for charging an energy storage of a motor vehicle. The charging station system comprises several charging stations, a back end and a communication device which can be managed by a user for charging the energy storage.

Currently, there are many charging station operators who purchase a charging station system, in particular charging stations, from one manufacturer. As a result, a user cannot immediately tell which charging station is from which charging station operator. The charging station operators can offer different electricity prices for charging the energy storage of the motor vehicle. These electricity prices may also fluctuate during a day. As a result, it is very difficult for a user to determine what the cost of a charging process is.

It is therefore an object of the invention to reliably inform a user who wishes to charge the energy storage of the motor vehicle about the costs incurred during a charging process of the energy storage.

The object is solved by patent claim 1, in particular by the characterizing part of patent claim 1. The object is thus solved by a method for operating a charging station system with which an energy storage of a motor vehicle is charged, wherein the charging station system comprises at least two charging stations, a back end and a communication device which is managed by a user for charging the energy storage, comprising the following steps:
a) the user starts an application of the communication device, which displays the charging stations to the user,
b) the user uses the communication device to select a charging station at which the user plans to charge the energy storage of the motor vehicle,
c) the communication device sends user-specific data and/or charging station-specific data to the back end, which the back end receives,
d) the back end checks user-specific and/or charging station-specific data sent by the communication device to the back end,
e) the back end sends tariff data to the communication device and/or to the charging station selected by the user, which the communication device and/or the charging station receives,

wherein with or after the sending of the tariff data the back end starts a timer which comprises a predetermined running time, wherein after the expiry of the predetermined running time the tariff data lose their validity and the selected charging station for charging the energy storage of the motor vehicle is blocked for the user. The method steps, in particular method steps a to e, can be carried out in any order.

In the context of the invention, the back end may be a computer server on which various data are stored. The timer may be integrated in the back end, for example. The timer is designed as a kind of counter, which starts generating data at one point in time and stops generating data at another point in time. This data can be time-based data.

By means of the tariff data, the user can be reliably informed about the costs of a charging process for charging the energy storage of the motor vehicle. By means of the timer, the user can rely on the fact that in a predetermined time window the tariff data remain unchanged and an increase of the costs for charging the energy storage of the motor vehicle is excluded. Therefore, it may be convenient that the predetermined running time of the timer is at least 15 minutes and at most 30 minutes. Thus, the user has sufficient time to connect or couple the energy storage of the motor vehicle to the selected charging station. In sum, the method according to the invention improves the convenience for the user when charging the energy storage of the motor vehicle. By the method according to the invention, transparency regarding the costs for a charging process by means of the selected charging station can be generated by sending the tariff data.

According to a preferred embodiment of the method, it can be provided that the back end checks at least the user-specific data sent by the user to the back end with regard to a release of the selected charging station and, in the event of a positive check, release data for the use of the selected charging station are generated, wherein the back end sends the release data for the use of the charging station to the communication device and/or to the charging station selected by the user, which are received by the communication device and/or the selected charging station. By checking the release data, it can be ensured that only the user who has stored his login data in the back end is allowed to use the selected charging station. The login data can be at least partially or completely the user-specific data. The security of the charging station system can be significantly improved if the back end compares the user-specific data with already stored data and, if the user-specific data match the stored data, generates the release data, which are preferably sent to the communication device and/or the selected charging station directly after the user-specific data have been compared with the stored data. A comparison of the user-specific data with already stored data can preferably be performed by arithmetic operations.

The computing operations can be performed quickly and reliably in the back end if the user-specific data that the communication device sends to the back end and which are received by the back end comprise a time stamp and/or a contract ID of the user. The contract ID may comprise, for example, personal data, in particular the user's surname and first name, birth data, address data and the like. The charging station-specific data may comprise, for example, the location data of the selected charging station at which the user plans to charge the energy storage of the motor vehicle and/or a charging station identifier uniquely identifying the charging station. The location data comprise the coordinates from the selected charging station. By means of the charging station identifier, the back end can uniquely identify the charging station. Furthermore, the time stamp may comprise information at which time the user sent the user-specific data to the back end.

According to a preferred embodiment of the method, it may be provided that the tariff data are generated at least from the user-specific data, wherein the tariff data comprise a price offer for charging the energy storage of the motor vehicle at the selected charging station, in particular for a charging process of the energy storage of the motor vehicle at the selected charging station. The tariff data may also comprise a non-binding price offer specifying the time window. It is also conceivable that before the charging process of the energy storage of the motor vehicle, it is additionally possible to perform a further price query at the back end in order to check whether the tariff data may have changed in the predetermined time window. If the price for charging the energy storage of the motor vehicle has changed positively for the user, the back end can send the changed tariff data to the communication device, which are received by the communication device. Furthermore, the back end may extend the tariff data, in particular a tariff data set of the back end. This may be the case, for example, if additional costs are incurred due to roaming or further system service providers. These additional costs can be flat or dependent on the amount of energy to be charged. Time-dependent cost elements can also be provided here.

Convenience can be further improved for the user if, after the user has started the application, a display device of the communication device shows the user the charging stations that can be used for release, preferably in a predetermined surrounding field in which the motor vehicle is located. In this case, it would then be possible to dispense with checking the user-specific data in the back end. It is possible that the usable charging stations are stored in a cloud or on a memory of the communication device. It is of course also conceivable that the back end or another server sends location data of the charging stations to be used to the communication device, which the communication device receives. Preferably, the location data of those charging stations are shown which are preferably located within a radius of maximum 0-50 km. With the help of the application, the user can also manually set and limit the radius. The communication device can, for example, be designed as a mobile device, in particular as a smartphone. It is also possible that the communication device is designed as an infotainment system that is arranged in a motor vehicle. It may be provided that the communication device is designed as a smartphone with a memory, wherein the application is stored on the memory. According to a further preferred embodiment of the method, it may be provided that the user sends, by means of the application, confirmation data comprising the acceptance of the price offer from the tariff data from the communication device to the back end, which the back end receives, wherein the back end, after receiving the confirmation data, sends the or further release data to the communication device and/or the selected charging station, which are received by the communication device and/or the selected charging station. The confirmation data may preferably comprise the declaration of intent that the user accepts the tariff data comprising the price offer sent by the back end to the communication device.

The invention and the technical environment are explained in more detail below. It should be noted that the description includes a particularly preferred embodiment of the invention, but the invention is not limited thereto.

The invention relates to a method for operating a charging station system. The charging station system, with which an energy storage of a motor vehicle can be charged, comprises at least two, preferably a plurality of charging stations, at least one back end and at least one communication device. To charge the energy storage of the motor vehicle, the user may manage the communication device.

For example, if the user is on the road with his vehicle and the energy storage of the motor vehicle is to be charged, the user can start an application of the communication device, which shows the charging stations arranged for him in the surroundings. Preferably, the charging stations are shown which are located in a predetermined surrounding field, preferably within a radius of, for example, 0-10 km. After the user has started the application, a display device of the communication device, for example in the form of a display, can show the user the charging stations that can be used for release, preferably in a predetermined surrounding field in which the motor vehicle is located.

The communication device can preferably be designed as a smartphone with a memory, wherein the application is stored on the memory. The user uses the communication device to select a charging station at which the user plans to charge the energy storage of the motor vehicle. The communication device sends the user-specific data and/or charging station-specific data to the back end, which the back end receives. The user-specific data that the communication device sends to the back end and which are received by the back end comprises a time stamp and/or a contract ID of the user. The time stamp comprises information at which time the user sent the user-specific data to the back end.

Preferably, in one embodiment of the invention, the charging station-specific data may comprise the location data of the selected charging station at which the user plans to charge the energy storage of the motor vehicle and/or a charging station identifier that uniquely identifies the charging station.

The back end checks the user-specific and/or charging station-specific data sent by the user to the back end. Thereafter, it may be convenient for the back end to send tariff data to the communication device and/or to the charging station selected by the user, which the communication device and/or the charging station receive. The tariff data may be generated at least from the user-specific data, wherein the tariff data comprise a price offer for charging the energy storage of the motor vehicle at the selected charging station, in particular for a charging process of the energy storage of the motor vehicle at the selected charging station. The tariff data may comprise the current electricity price by which the price offer for charging the energy storage of the motor vehicle is calculated. The price offer may also be provided as a non-binding price offer to the user, which the user may accept within the predetermined running time.

Additionally and/or also later, release data may be sent from the back end to the communication device, which the communication device receives. The back end can at least check the user-specific data sent by the user to the back end with regard to a release of the selected charging station and, in case of a positive check, generate the release data for use of the selected charging station, wherein the back end sends the release data for use of the charging station to the communication device and/or to the charging station selected by the user, which are received by the communication device and/or the selected charging station. Furthermore, the back end can compare the user-specific data with already stored data and, if the user-specific data match the stored data, generate the release data, which are preferably sent to the communication device and/or the selected charging station directly after the user-specific data have been compared with the stored data.

With or after sending the tariff data, the back end starts a timer, which has a predetermined running time, preferably a running time of at least 15 minutes and at most 30 minutes, wherein after the predetermined running time has expired, the tariff data loses its validity and the selected charging station for charging the energy storage of the motor vehicle is blocked for the user.

Further the user may send, by means of the application, confirmation data, which comprise the acceptance of the price offer from the tariff data, from the communication device to the back end, which the back end receives. The back end, after receiving the confirmation data, sends the or further release data to the communication device and/or the selected charging station, which can be received by the communication device and/or the selected charging station.

For example, when the user drives the motor vehicle to the selected charging station, the user can electrically connect the energy storage of the motor vehicle to the selected charging station with a charging cable to charge the energy storage with electricity.

If the user does not connect the energy storage of the motor vehicle to the charging station, for example by means of the charging cable, within the predetermined running time, the selected charging station is blocked again for the user. This means that an electricity flow between the charging station and the energy storage is excluded.

Alternatively, it is possible that a large number of charging stations in the vicinity of the communication device are already automatically taken into account by the back end. This may be the case if, for example, the back end knows where the communication device is located. In this case, one could refrain from sending the location data of the charging station to the back end, which the back end receives.

It is also conceivable to perform an additional price query at the back end before the loading process in order to check whether the tariff data has changed in the meantime.

1-10. (canceled)

11. A method for operating a charging station system with which an energy storage of a motor vehicle is charged, wherein the charging station system comprises at least two charging stations, a back end, and a communication device which is managed by a user for charging the energy storage, comprising the following steps:
a) the user starts an application of the communication device, which displays the charging stations to the user,
b) the user uses the communication device to select a charging station at which the user plans to charge the energy storage of the motor vehicle,
c) the communication device sends at least user-specific data or charging station-specific data to the back end, which the back end receives,
d) the back end checks at least the user-specific or charging station-specific data sent by the communication device to the back end,
e) the back end sends tariff data at least to the communication device or to the charging station selected by the user, which at least the communication device or the charging station receives,
wherein
with or after the sending of the tariff data the back end starts a timer which comprises a predetermined running time, wherein after the expiry of the predetermined running time the tariff data lose their validity and the selected charging station for charging the energy storage of the motor vehicle is blocked for the user.

12. The method according to claim 11, wherein the back end checks at least the user-specific data sent by the user to the back end with regard to a release of the selected charging station and, in case of a positive check, release data for the use of the selected charging station are generated, wherein the back end sends the release data for the use of the charging station at least to the communication device or to the charging station selected by the user, which are received by at least the communication device or the selected charging station.

13. The method according to claim 12, wherein the back end compares the user-specific data with already stored data and, if the user-specific data match the stored data, generates the release data.

14. The method according to claim 12, wherein the back end compares the user-specific data with already stored data and, if the user-specific data match the stored data, generates the release data, which are sent at least to the communication device or the selected charging station directly after the user-specific data have been compared with the stored data.

15. The method according to claim 11, wherein the user-specific data that the communication device sends to the back end and which are received by the back end comprise at least a time stamp or a contract ID of the user.

16. The method according to claim 15, wherein the time stamp comprises information at which time the user sent the user-specific data to the back end.

17. The method according to claim 11, wherein the tariff data are generated at least from the user-specific data, wherein the tariff data comprise a price offer for charging the energy storage of the motor vehicle at the selected charging station.

18. The method according to claim 11, wherein the tariff data are generated at least from the user-specific data, wherein the tariff data comprise a price offer for charging the energy storage of the motor vehicle at the selected charging station for a charging process of the energy storage of the motor vehicle at the selected charging station.

19. The method according to claim 11, wherein after the user has started the application, a display device of the communication device shows the user the charging stations that can be used for release.

20. The method according to claim 11, wherein after the user has started the application, a display device of the communication device shows the user the charging stations that can be used for release in a predetermined surrounding field in which the motor vehicle is located.

21. The method according to claim 11, wherein the predetermined running time of the timer is at least 15 minutes and at most 30 minutes.

22. The method according to claim 12, wherein the user sends, by means of the application, confirmation data comprising the acceptance of the price offer from the tariff data from the communication device to the back end, which the back end receives, wherein the back end, after receiving the confirmation data, sends the or further release data at least to the communication device or the selected charging station, which are received at least by the communication device or the selected charging station.

23. The method according to claim 11, wherein the communication device is designed as a smartphone with a memory, wherein the application is stored on the memory.
